(19) United States
(12) Patent Application Publication
(10) Pub. No.: US 2026/0291555 A1
(43) Pub. Date: Sep. 24, 2026

(54) METHODS FOR IDENTIFYING AND CORRECTING PHASE AND/OR AMPLITUDE ERRORS IN ACTIVE ANTENNA FEED NETWORKS

(71) Applicant: Outdoor Wireless Networks LLC, Richardson, TX (US)

(72) Inventor: Mikko Juhani Junttila, Oulu (FI)

(21) Appl. No.: 19/476,256

(22) PCT Filed: Mar. 14, 2024
(86) PCT No.: PCT/US2024/019821

§ 371 Date: Oct. 17, 2025

Related U.S. Application Data
(60) Provisional application No. 63/460,632, filed on Apr. 20, 2023.

(51) Int. Cl. H04B 7/0426; H04B 7/01; H04B 17/12; H04B 17/21

(52) U.S. Cl. CPC H04B 7/043; H04B 7/01; H04B 17/12; H04B 17/221

(57) ABSTRACT

A method of operating a beamforming antenna system that includes a multi-column array of radiating elements and a beamforming radio comprises adjusting weights applied in the beamforming radio based on data corresponding to phase versus frequency responses for a plurality of feed networks for respective sub-arrays of radiating elements included in a first column of radiating elements of the multi-column array of radiating elements.

### CROSS-REFERENCE TO RELATED APPLICATION

The present application claims priority under 35 U.S.C. § 119 to U.S. Provisional Patent Application Ser. No. 63/460,632, filed Apr. 20, 2023, the entire content of which is incorporated herein by reference as if set forth fully herein.

### FIELD

The present invention relates to cellular communications systems and, more particularly, to cellular communications systems that employ active antennas.

### BACKGROUND

Cellular communications systems are used to provide wireless communications to fixed and mobile subscribers. In a typical cellular communications system, a geographic area is divided into a series of regions that are referred to as “cells,” and each cell is served by a base station. Each base station may include baseband equipment, radios and base station antennas that are used to provide two-way radio frequency (“RF”) communications with subscribers that are within the cell.

FIG. 1 is a schematic diagram of a conventional cellular base station 10. The base station 10 includes several base station antennas 20 that are mounted on a raised structure 30 such as an antenna tower. Baseband equipment 40 may be mounted at the base of the tower 30 and cabling connections 42 may connect the baseband equipment 40 to remote radio heads (not visible in FIG. 1) that are mounted on the antenna tower 30 behind each base station antenna 20.

Base station antennas such as the base station antennas 20 of FIG. 1, typically include multiple phase-controlled arrays of radiating elements, with the radiating elements in each array arranged in one or more vertical columns when the antenna is mounted for use (herein “vertical” refers to a direction that is generally perpendicular relative to the plane defined by the horizon). Each radiating element acts as an individual antenna element that can be used to transmit and receive RF signals. The radiating elements are arranged into phase-controlled arrays of radiating elements as this allows the RF energy transmitted or received by the radiating elements in a given one of the arrays to be concentrated in a desired direction. This is accomplished by subdividing an RF signal that is to be transmitted into a plurality of sub-components, and then setting the amplitudes and phases of the sub-components that are passed to each radiating element in the array in a manner that generates an antenna beam that focuses the RF energy in a desired direction. The “gain” of a phase-controlled array of radiating elements in a given direction is a measure of the ability of the array to concentrate the RF energy in that direction. The radiation pattern that is generated by a phase-controlled array of radiating elements, which is also referred to as an “antenna beam,” is a compilation of the gain of the antenna beam in all different directions.

Most base station antennas are “passive” antennas that are designed to generate static antenna beams that are shaped to provide service to a pre-defined coverage area such as the cell or a portion thereof that is typically referred to as a “sector.” Most cells of a cellular communication network are sub-divided into three 1200 sectors in the horizontal or “azimuth” plane, with a separate base station antenna provided for each 120° sector. The static antenna beams generated by the phase-controlled arrays of the above-described passive base station antennas are typically designed to have minimum gain levels throughout the pre-defined coverage area, and to have much lower gain levels outside of the coverage area to reduce interference with adjacent cells or sectors. Referring again to FIG. 1, a phase-controlled array of radiating elements in each base station antenna 20 may generate a respective antenna beam 50 (shown schematically in FIG. 1) that provides service to a 120° sector in the horizontal or “azimuth” plane.

As noted above, passive base station antennas generate antenna beams that have a generally fixed shape and boresight pointing direction (the boresight pointing direction refers to the direction where the antenna beam exhibits peak gain). The shape and boresight pointing direction of the antenna beams are referred to as being “generally” fixed (as compared to being completely fixed) because most modern base station antennas do have so-called remote electronic downtilt or “RET” capabilities, which refers to an ability for a wireless network operator to electronically change the “downtilt” angle (i.e., the angle relative to the horizon of the boresight pointing direction of the antenna beam) of the antenna beams generated by the phase-controlled arrays of radiating elements in the antenna. The operator may perform such downtilt angle changes by transmitting control signals to the base station antenna 20 that alter the amplitude and/or phase of the sub-components of an RF signal that are transmitted/received through the respective radiating elements of the array that generates the antenna beam in a manner that acts to electronically adjust the downtilt angle of the antenna beam.

In order to increase capacity, many cellular base stations now employ beamforming radios and “active” antennas that include phase-controlled multi-column arrays that include multiple columns of radiating elements. The multi-column array is divided into a plurality of sub-arrays, where each sub-array includes one or more radiating elements. The radiating elements in each sub-array are coupled to a respective pair of ports of a beamforming radio (one radio port for each polarization). The beamforming radio may adjust the amplitudes and phases of the sub-components of RF signals that are passed to each sub-array so that the RF energy radiated by each sub-array constructively combines in desired directions to form more focused, higher gain, antenna beams that have narrowed beamwidths in one or both of the azimuth and elevation planes. Typically a beamforming antenna system can generate different antenna beams on a time-slot-by-time-slot basis so that these high gain antenna beams can be electronically steered throughout a sector during different time-slots to provide coverage to the subscribers throughout the entire sector.

As an example, a multi-column array may have eight columns of dual-polarized radiating elements, with eight radiating elements per column, so that the array includes for a total of sixty-four radiating elements. Each column may be divided into two four radiating element sub-arrays so that the array includes a total of sixteen sub-arrays. A thirty-two port beamforming radio may be connected to the multi-column array, with two radio ports (one for each polarization) coupled to each sub-array. The beamforming radio effectively divides an RF signal that is to be transmitted into a plurality of sub-components, and sets the relative amplitudes and phases of these sub-components so that the radiation patterns emitted by each sub-array in response to its respective sub-component will constructively combine to generate a composite antenna beam that points in a desired direction and that is focused in both the azimuth and elevation planes.

Unfortunately, the relative amplitude and phases of the sub-components of the RF signal that are generated by the radio may change in undesired ways as the sub-components are amplified in the radio and pass to the multi-column array. Variations in the relative amplitudes and phases may arise, for example, because of non-linearities in the amplifiers that are used to amplify the respective transmitted and received signals, differences in the lengths of the RF transmission line connections between the different radio ports and the columns of radiating elements in the array, variations in temperature and the like. If the relative amplitudes and phases change, then characteristics of the resulting antenna beam such as the directivity, pointing direction, side lobe levels and the like may be degraded. While some of the causes for the amplitude and phase variations may tend to be static (i.e., they do not change over time), others may be dynamic, and hence more difficult to compensate.

In order to reduce the impact of the above-discussed amplitude and phase variations, active antennas typically include a calibration circuit that samples the sub-components of the RF signal that are to be passed to each sub-array of radiating elements in a multi-column array and passes these samples back to the beamforming radio. The calibration circuit may comprise a plurality of directional couplers, each of which is configured to tap RF energy from a respective one of the RF transmission paths that extend between the radio ports and the respective sub-arrays, as well as a calibration combiner that is used to combine the RF energy that is tapped from of each of these RF transmission paths. The output of the calibration combiner is coupled to a calibration port on the active antenna, which in turn is coupled back to the beamforming radio. The beamforming radio may use the samples of each sub-component of the RF signal to determine the relative amplitude and/or phase variations along each transmission path, and may then adjust the applied amplitude and phase weights to account for these variations.

### SUMMARY

Pursuant to some embodiments of the present invention, methods of operating a beamforming antenna system that includes a multi-column array of radiating elements and a beamforming radio. Pursuant to these methods, weights applied in the beamforming radio are adjusted based on data corresponding to phase versus frequency responses for a plurality of feed networks for respective sub-arrays of radiating elements included in a first column of radiating elements of the multi-column array of radiating elements.

In some embodiments, the data corresponding to the phase versus frequency responses for the plurality of feed networks for the respective sub-arrays of radiating elements included in the first column of radiating elements comprises information regarding the relative phase shifts for sub-components of RF signals traversing the feed networks to each radiating element in the first column of radiating elements for a plurality of different frequencies.

In some embodiments, these methods further comprise measuring the data corresponding to the phase versus frequency responses of the plurality of feed networks for the respective sub-arrays of radiating elements included in the first column of radiating elements. In some embodiments, these methods further comprise inputting into the beamforming radio the measured data corresponding to the phase versus frequency responses of the plurality of feed networks for the respective sub-arrays of radiating elements included in the first column of radiating elements. In some embodiments, these methods further comprise determining corrective weights based on the measured data corresponding to the phase versus frequency responses of the plurality of feed networks for the respective sub-arrays of radiating elements included in the first column of radiating elements and then inputting the corrective weights into the beamforming radio.

In some embodiments, the data corresponding to the phase versus frequency responses of the plurality of feed networks for the respective sub-arrays of radiating elements included in the first column of radiating elements comprises measured phase shifts for each radiating element in the first column at a plurality of different frequencies.

In some embodiments, the adjustment to the weights applied in the beamforming radio are also based on data corresponding to an amplitude versus frequency response of the plurality of feed networks for the respective sub-arrays of radiating elements included in the first column of radiating elements.

In some embodiments, these methods further comprise adjusting weights applied in the beamforming radio based on data corresponding to the phase versus frequency responses of a plurality of feed networks for the respective sub-arrays of radiating elements included in each of the columns of radiating elements in the multi-column array of radiating elements other than the first column.

Pursuant to further embodiments of the present invention, methods of operating a beamforming antenna system that includes a multi-column array of radiating elements and a beamforming radio are provided. Pursuant to these methods, weights applied in the beamforming radio to RF signals that are output to at least some of a plurality of sub-arrays of the multi-column array of radiating elements are adjusted based on information regarding the phase shifts experienced by RF signals when traversing the feed networks that connect respective ports of the beamforming radio to each radiating element in the multi-column array of radiating elements.

In some embodiments, the information regarding the phase shifts experienced by RF signals when traversing the feed networks that connect the ports of the beamforming radio to each radiating element in the multi-column array of radiating elements includes information regarding the phase shifts experienced by RF signals when traversing the feed networks that connect the ports of the beamforming radio to each radiating element in the multi-column array of radiating elements for each of a plurality of different frequencies.

In some embodiments, these methods further comprise measuring the information regarding the phase shifts experienced by the of RF signals passed from the beamforming radio to each radiating element in the multi-column array of radiating elements at the plurality of different frequencies.

In some embodiments, these methods further comprise inputting the information regarding the relative phases of RF signals passed from the beamforming radio to each radiating element in the multi-column array of radiating elements at the plurality of different frequencies into the beamforming radio.

In some embodiments, the information regarding the relative phases of RF signals passed from the beamforming radio to each radiating element in the multi-column array of radiating elements at the plurality of different frequencies comprises measured phase values for each radiating element in each column at the plurality of different frequencies.

Pursuant to additional embodiments of the present invention, methods of at least partially compensating for phase errors in feed networks for respective columns of a multi-column array of radiating elements are provided. Pursuant to these methods, phase shifts experienced by the respective sub-components of an RF signal traversing a feed network for a first column of radiating elements of the multi-column array of radiating elements are determined at a plurality of different frequencies. The determined phase shifts are then stored.

In some embodiments, the phase delay information is stored in an electronic file.

In some embodiments, these methods further comprise inputting the determined phase shifts into the beamforming radio. In some embodiments, these methods further comprise adjusting weights applied by the beamforming radio based on the determined phase shifts.

In some embodiments, determining the phase shifts experienced by the respective sub-components of the RF signal traversing a feed network for a first column of radiating elements information for the at least some of the radiating elements in the multi-column array of radiating elements at the plurality of different frequencies comprises inputting first RF signals having the plurality of different frequencies to a feed network for the first column of radiating elements and measuring phases of second RF signals that are provided at each radiating element in the first column of radiating elements in response to the first RF signals.

Pursuant to additional embodiments of the present invention, methods of determining phase errors in a feed network for a first column of radiating elements of a multi-column array of radiating elements are provided. Pursuant to these methods, data corresponding to a phase versus frequency responses of a plurality of feed networks for the first column of radiating elements is measured.

In some embodiments, the measured data corresponding to the phase versus frequency response of the feed network for the first column of radiating elements comprises measured phase delay information to each of the radiating elements in the first column for a plurality of different frequencies.

In some embodiments, these methods further comprise inputting the measured data into the beamforming radio. In some embodiments, these methods further comprise adjusting weights applied by the beamforming radio based on the measured data.

In some embodiments, these methods further comprise determining corrective weights that based on the measured data. In some embodiments, these methods further comprise inputting the corrective weights into the beamforming radio.

### BRIEF DESCRIPTION OF THE DRAWINGS

FIG. 1 is a schematic diagram illustrating a conventional cellular base station.

FIG. 2A is a schematic rear perspective view of an active antenna.

FIG. 2B is a schematic front view of the active antenna of FIG. 2A with a radome thereof omitted that illustrates a multi-column array included in the antenna.

FIG. 2C is a schematic block diagram of the calibration circuit for one polarization that is included in the active antenna of FIG. 2A.

FIG. 3 is a schematic block diagram illustrating the calibration loop and feed network for the first polarization radiators of the radiating elements in the first column of the multi-column array of FIG. 2B.

FIG. 4A is a schematic graph illustrating the phase versus frequency response of RF signals traversing the calibration loop of FIG. 3 when the antenna of FIG. 3 is an ideal antenna.

FIG. 4B is a schematic graph illustrating a typical phase versus frequency response for RF signals traversing the calibration loop of FIG. 3 when the antenna of FIG. 3 is an actual (non-ideal) antenna.

FIG. 5A is a schematic graph illustrating the phase versus frequency response of RF transmission paths in the feed network for the first column of radiating elements (FIG. 3) when the feed network has ideal characteristics.

FIG. 5B is a schematic graph illustrating a typical phase versus frequency response of the RF transmission paths in the feed network for the first column of radiating elements (FIG. 3) for an actual (non-ideal) feed network.

FIG. 6A is a table illustrating the phase offsets in a feed network for a first column of a multi-column array and the associated phase weights applied by a beamforming radio to generate a desired antenna beam in an ideal antenna.

FIG. 6B is an elevation plot (in Cartesian graph format) of the antenna beam generated by the first column of radiating elements of the ideal antenna corresponding to FIG. 6A.

FIG. 6C is an elevation plot (in Polar graph format) of the antenna beam generated by the first column of radiating elements of the ideal antenna corresponding to FIG. 6A.

FIG. 7A is a table illustrating how phase errors that can arise in a non-ideal antenna can impact the phase offsets to each radiating element in a feed network for a first column of a multi-column array.

FIG. 7B is an elevation plot (in Cartesian graph format) of the antenna beam generated by the first column of radiating elements having the phase offsets, phase weights and phase errors shown in FIG. 7A.

FIG. 7C is an elevation plot (in Polar graph format) of the antenna beam generated by the first column of radiating elements having the phase offsets, phase weights and phase errors shown in FIG. 7A.

FIG. 8A is a table illustrating how phase error corrections can be applied to partially compensate for the phase errors shown in the table of FIG. 7A.

FIG. 8B is an elevation plot (in Cartesian graph format) of the antenna beam generated by the first column of radiating elements having the phase offsets, phase weights, phase errors and phase error corrections shown in the table of FIG. 8A.

FIG. 8C is an elevation plot (in Polar graph format) of the antenna beam generated by the first column of radiating elements having the phase offsets, phase weights, phase errors and phase error corrections shown in the table of FIG. 8A.

FIG. 9 is a schematic block diagram illustrating how the RF transmission paths feeding different columns of a multi-column array may have different electrical lengths.

FIG. 10 is a schematic block diagram illustrating portions of a passive base station antenna that includes an active antenna mounted behind the passive antenna.

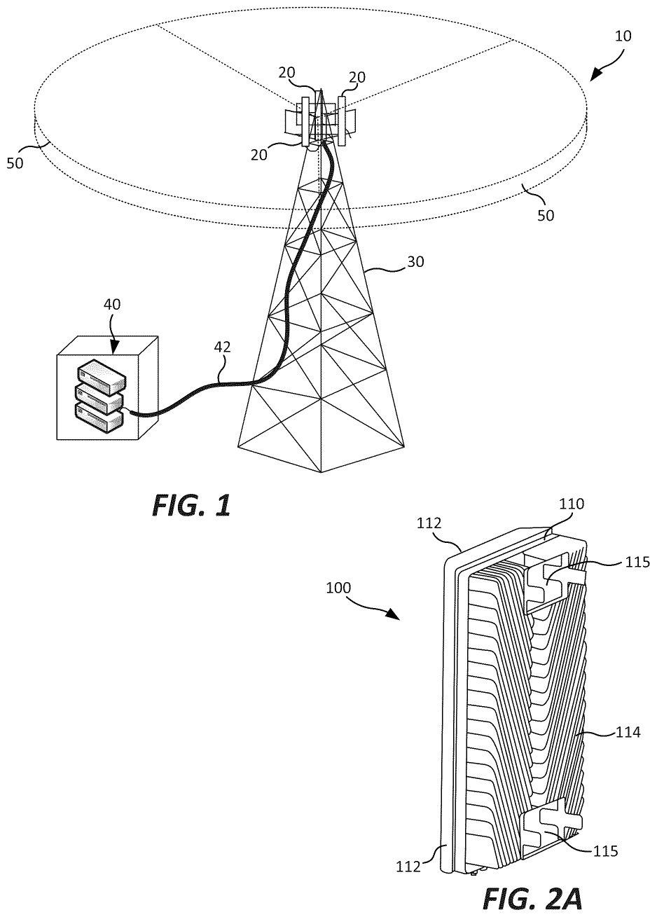

### DETAILED DESCRIPTION

As discussed above, most beamforming antenna systems include a multi-column array that is divided into a plurality of individually-fed sub-arrays arrays and a beamforming radio. The beamforming radio includes first and second radio port for each sub-array of radiating elements included in the multi-column array. The first radio port for each sub-array feeds the first polarization radiators of the radiating element in the sub-array, and the second radio port for each sub-array feeds the second polarization radiators of the radiating element in the sub-array. While most multi-column arrays use dual-polarized radiating elements, the discussion that follows will, for the most part, only show the feed networks for one polarization for purposes of simplifying the discussion. It will be appreciated that the feed networks for the first polarization radiators will typically be duplicated to feed the second polarization radiators of the radiating elements in the multi-column array.

Most multi-column arrays employ wideband radiating elements that are configured to operate over a relatively broad frequency range (e.g., the 3.1-4.2 GHZ frequency band). In operation, a multi-column array will only transmit and receive RF signals in a relatively narrow frequency band such as, for example, a 10-20 MHz frequency band. By providing arrays that have wideband radiating elements, cellular operators may use the same antenna to support cellular service at different base stations where the cellular operator is licensed to use different sub-bands.

Typically, first and second feed networks are used to feed the individual radiating elements included in each sub-array of a multi-column array. In particular, the first feed network for a sub-array feeds the first polarization radiators of the radiating elements in the sub-array and the second feed network for the sub-array feeds the second polarization radiators of the radiating elements in the sub-array. Each feed network is typically designed (during transmit operations) to split the RF signals output from its associated radio port into a plurality of sub-components, apply a predetermined phase shift to each sub-component (which may include a fixed phase shift and/or a phase shift for impacting beam shape characteristics in the elevation plane), and to pass the phase-shifted sub-components of the RF signal to the respective radiating elements in the sub-array. Thus, each feed network includes a set of RF transmission paths that connect an input of the feed network to a radiator of each respective radiating element in the sub-array of radiating elements fed by the feed network.

The length of each RF transmission path in the feed networks for the sub-arrays of the multi-column array are carefully controlled so that RF signals at a given frequency that traverse the RF transmission path will experience a predetermined amount of phase shift. In an “ideal” antenna, the feed networks for the multi-column array will not introduce any phase distortions that can degrade the antenna beams generated by the respective sub-arrays of radiating elements. Unfortunately, however, in practice “crosstalk” may occur between the RF transmission paths of a feed network, and this crosstalk can distort the phase versus frequency response of the sub-components of an RF signal that are passed to the radiating elements in the sub-array fed by the feed network. This is particularly true in multi-column arrays having close column spacings (e.g., columns spaced apart by about one half the wavelength corresponding to the operating frequency band of the radiating elements in the array). These distortions will not be detected by the calibration circuit for the multi-column array, and hence the beamforming radio cannot correct for these phase distortions using the calibration data collected by the calibration network. As a result, the phase distortions are uncorrected and tend to degrade the characteristics of the antenna beams generated by the multi-column array.

Moreover, the phase distortion along each RF transmission path of a feed network may vary non-linearly with frequency. Thus, for example, at a first frequency, a first RF transmission path in a feed network may have a phase delay that is X° greater than a predetermined phase delay at the first frequency (the predetermined phase delay is the phase delay that would be present in an ideal antenna), while at a second frequency the first RF transmission path in the feed network may have a phase delay that is Y° less than a predetermined phase delay at the second frequency. The phase shift, as a function of frequency, that RF signals traversing a first RF transmission path of a feed network will undergo is referred to herein as the phase versus frequency response for the RF transmission path. Since a feed network for a sub-array of radiating elements has a plurality of RF transmission paths (specifically a separate RF transmission path for each radiator of the radiating elements in the sub-array fed by the feed network), a feed network will have a plurality of associated phase versus frequency responses.

Pursuant to embodiments of the present invention, the phase (as well as amplitude) distortions in each feed network may be determined by measuring the phase delay (or other parameter from which the phase delays or relative phase delays may be determined) for each sub-array (at each polarization) of the multi-column array. These phase delays (or equivalent information) may be stored to a phase error file, and the phase error file may be input to the beamforming radio that will be used in conjunction with the multi-column array. The beamforming radio may then apply corrective phase weights to compensate for the phase distortions in the feed networks, which may improve the characteristics of the antenna beams generated by the multi-column array. Alternatively, the measured phase delays (or equivalent parameters) may be used to determine corrective radio weights that may at least partially compensate for the phase errors introduced in the feed networks, and these corrective weights may be input to the beamforming radio.

The techniques disclosed herein may improve the shape, pointing direction and/or gain of the antenna beams generated by multi-column arrays. In addition, the techniques may also be used to compensate for other sources of phase distortion such as, for example, situations where the electrical length of the RF transmission paths from the radio ports to different sub-arrays differs, or the effects that strong mutual coupling that may occur between the beamforming antenna in a vendor supplied active antenna and elements of a passive base station antenna on which the active antenna is mounted during normal use may have on the phase delay of various RF transmission paths in the active antenna.

Pursuant to some embodiments of the present invention, methods of operating a beamforming antenna system are provided. The beamforming antenna system may include a multi-column array of radiating elements and a beamforming radio. The weights applied in the beamforming radio are adjusted based on data corresponding to phase versus frequency responses for a plurality of feed networks for respective sub-arrays of radiating elements included in a first column of radiating elements of the multi-column array of radiating elements. In this manner, the beamforming radio may partially or fully compensate for undesired frequency dependent phase variations along the RF transmission paths in the feed networks for the first column of radiating elements. The same technique may be applied for all of the columns of radiating elements in the multi-column array. It will be appreciated that if dual-polarized radiating elements are used, the phase weights applied in the beamforming radio may be adjusted separately for each polarization based on data corresponding to the phase versus frequency responses of the feed networks for each polarization.

The data corresponding to the phase versus frequency responses for the plurality of feed networks for the respective sub-arrays of radiating elements included in the first column of radiating elements may be, for example, information regarding the relative phase shifts for sub-components of RF signals traversing the feed networks to each radiating element in the first column of radiating elements for a plurality of different frequencies. The data corresponding to the phase versus frequency responses of the plurality of feed networks for the respective sub-arrays of radiating elements included in the first column of radiating elements may be measured (e.g., at the factory as part of the manufacturing process). The measured data may be input into the beamforming radio. Corrective weights may be determined based on the measured data. These corrective weights may be determined by the radio or may be input to the radio instead of the measured data.

Pursuant to further embodiments of the present invention, methods of operating a beamforming antenna system that includes a multi-column array of radiating elements and a beamforming radio are provided in which the weights applied in the beamforming radio to the RF signals that are output to at least some of a plurality of sub-arrays of the multi-column array of radiating elements are based on information regarding the phase shifts experienced by RF signals when traversing the feed networks that connect respective ports of the beamforming radio to each radiating element in the multi-column array of radiating elements. The adjustments to the phase weights may be applied in any appropriate fashion including, for example, by determining desired weights and then further applying corrective weights or by determining a single composite weight that is a combination of the desired weight and the corrective weight.

Pursuant to still further embodiments of the present invention, methods of at least partially compensating for phase errors in feed networks for respective columns of a multi-column array of radiating elements are provided. Pursuant to these methods, phase shifts experienced by the respective sub-components of an RF signal traversing a feed network for a first column of radiating elements of the multi-column array of radiating elements are determined at a plurality of different frequencies. The determined phase shifts may then be stored (e.g., in an electronic file).

Pursuant to yet additional embodiments of the present invention, methods of determining phase errors in a corporate feed network for a first column of radiating elements of a multi-column array of radiating elements are provided. Pursuant to these methods, data corresponding to a phase versus frequency responses of a plurality of corporate feed networks for the first column of radiating elements are measured.

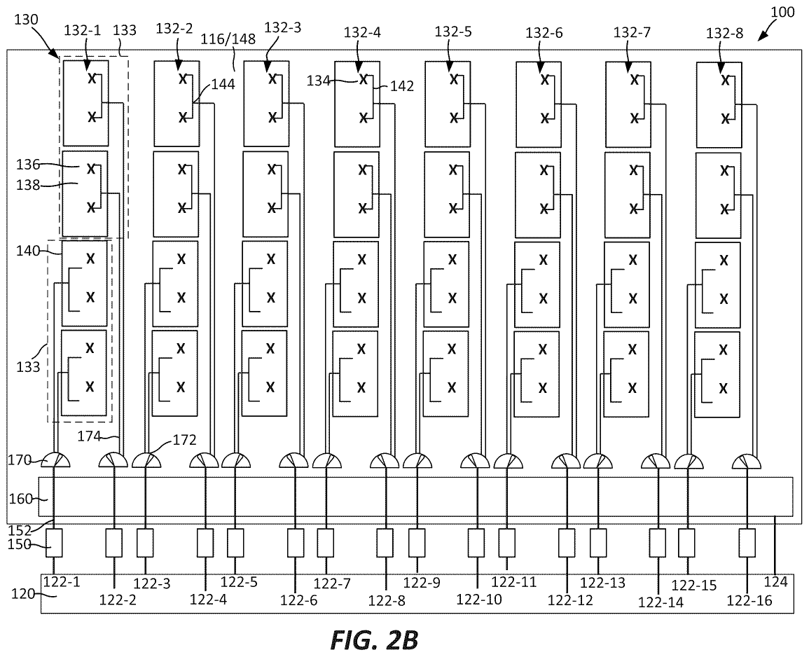

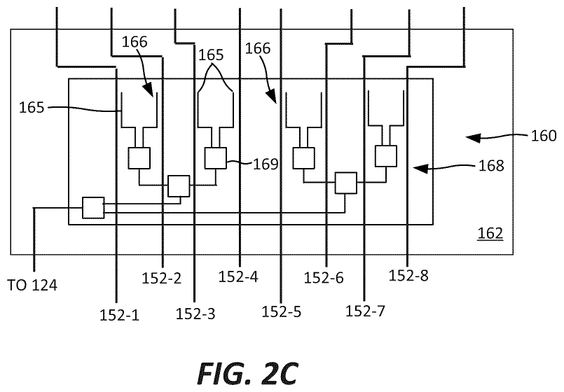

Aspects of the present invention will now be in discussed in greater detail with reference to FIGS. 2A-10, which illustrate example embodiments of the present invention.

FIG. 2A is a schematic perspective view of an active antenna 100 in which the techniques according to embodiments of the present invention may be practiced. As shown in FIG. 2A, the active antenna 100 includes a housing 110 that may provide structural support (e.g., for mounting hardware) and that protects internal components of the antenna 100 from environmental factors such as wind, water, moisture, dust, animals, insects and the like. At least a front surface of the housing 110 may comprise a radome 112 that is substantially transparent to RF energy in the operating frequency band(s) of the active antenna 100. A beamforming radio 120 (see FIG. 2B) may be mounted within the housing 110. Back and/or side portions of the housing may include metal heat fins 114 that are designed to vent heat generated by the beamforming radio 120 from the housing 110. Mounting brackets 115 may also be provided.

FIG. 2B is a schematic front view of the active antenna 100 of FIG. 2A with the radome 112 thereof omitted. As shown in FIG. 2B, the active antenna 100 has a multi-column array 130 of dual-polarized radiating elements 134. The combination of the beamforming radio 120 and the multi-column array 130 may be referred to herein as a beamforming antenna system. The multi-column array 130 includes a total of eight columns 132-1 through 132-8 of radiating elements 134, with each column 132 having eight radiating elements 134. As shown by the dashed boxes included in the first column 132-1 of beamforming array 130, each column 132 of radiating elements 134 is divided into two sub-arrays 133, where each sub-array 133 includes four radiating elements 134. Each sub-array 133 is fed by a different port 122 of the beamforming radio 120. While FIG. 2B illustrates one example of a beamforming antenna system, it will be appreciated that other numbers of radiating elements 134 may be included in each column 132, and that different numbers of columns 132 may be included in the multi-column array 130 and/or that different numbers of sub-arrays may be included in each column 132. Each column 132 of radiating elements 134 may be oriented generally vertically with respect to the horizon when the active antenna 100 is mounted for use. Each dual-polarized radiating element 134 includes a first polarization radiator 136 and a second polarization radiator 138. Any appropriate radiating elements 134 may be used. In an example embodiment, each radiating element 134 may comprise a slant −45°/+45° polarization cross-dipole radiating element that includes a feed stalk and a −45° dipole radiator 136 and a slant +45° polarization dipole radiator 138 mounted in a cross configuration on a front end of the feed stalk. The radiating elements 134 are shown schematically in FIG. 2B using large X's to show that slant −45°/+45° polarization cross-dipole radiating elements used. In other embodiments, dual-polarized patch radiating elements may be used.

The radiating elements 134 are mounted to extend forwardly from a backplane 116. The backplane 116 may comprise or include a reflector 118, which may be implemented as a flat metal or metallized surface. The reflector 118 may serve as a ground plane for the radiating elements 134 and may also reflect forwardly RF radiation that is emitted rearwardly by the radiating elements 134. The radiating elements 134 are mounted on feedboard printed circuit boards 140 (referred to herein as feedboards 140). RF transmission lines 142 and power dividers 144 on the feedboards 140 may split RF signals input to the feedboards 140 and deliver the split components of the RF signal to either the first polarization radiators 136 or the second polarization radiators 138 of the radiating elements 134.

The beamforming radio 120 includes a plurality of radio ports 122. RF signals are coupled between the radio ports 122 and the sub-arrays 133 of radiating elements 134. Only the radio ports 122 and feed networks for the first polarization radiators 136 (e.g., the −45° dipole radiators) of the radiating elements 134 are shown in FIG. 2B to simplify the figure. As shown, for each polarization, the radio includes a total of sixteen radio ports 122, namely one radio port 122 for each sub-array 133 (and two radio ports 122 for each column 132). The radio further includes a calibration port 124 (see discussion below). The radio ports 122 are internal to active antenna 100 and hence are not visible in FIG. 2A. In some cases, the beamforming radio 120 may be separate from active antenna 100 (e.g., mounted on the back of the active antenna 100 or mounted adjacent the active antenna 100). In such embodiments, the radio ports 122 may be connected to RF ports on active antenna 100 via coaxial cables or other RF transmission lines.

As shown in FIG. 2B, each radio port 122 may be connected to an input of a respective filter 150. The filters 150 may comprise, for example, interference mitigation filters that are designed to filter out intermodulation products and other out-of-band RF energy. Respective RF transmission lines 152 extend from the output of each filter 150 to a respective one of a plurality of phase shifters 170. Each RF transmission line 152 may include a segment (e.g., a microstrip segment) that traverses a calibration circuit 160, which is discussed in greater detail below with reference to FIG. 2C. The calibration circuit 160 taps a small amount of RF energy from each RF transmission line 152. Each phase shifter 170 is configured to split RF signals provided from its associated RF transmission line 152 into a plurality of sub-components, and to then apply an adjustable phase progression to these sub-components of the RF signal. The outputs of each phase shifter 170 connect to the feed boards 140 of a respective sub-array 133 of radiating elements 134 in order to allow RF signals to pass between the phase shifters 170 and the feed boards 140. Each sub-array 133 has an associated first polarization phase shifter 170 and an associated second polarization phase shifter 170. In the example embodiment of FIG. 2B, the first polarization phase shifter 170 for each sub-array 133 has two outputs 172 that connect (via two respective phase cables 174) to respective ones of the RF transmission lines 142 that are provided on each the two feedboards 140 in the sub-array 133. Each RF transmission line 142 passes through a respective power divider 144 so that the RF transmission line 142 can feed the first polarization radiators 136 of the two radiating elements 134 that are mounted on the feed board 140. In this fashion, each output 172 of the first polarization phase shifter 170 may be connected to the first polarization radiators 136 of the two radiating elements 134 on a respective one of the feed boards 140.

The active antenna 100 generates high gain antenna beams by using the beamforming radio 120 to set the amplitudes and phases of the RF signals that are fed to the individual sub-arrays 133 so that the individual antenna beams generated by each sub-array 133 of radiating elements 134 constructively combine to generate narrow, high gain antenna beams that point in desired directions. To achieve these high gains, the amplitudes and phases of the RF signals fed to each sub-array 133 of the multi-column array 130 may be controlled, as unintended deviations from the desired amplitudes and phases can reduce the peak gain of the antenna beams and/or degrade the shape, pointing direction side lobe levels or other characteristics of the generated antenna beams.

Unfortunately, the amplitudes and phases of the RF signals may vary due to a variety of factors, some of which are relatively static, and others of which may dynamically change during operation. These variations may arise, for example, due to non-linearities in the amplifiers that amplify the RF signals (these amplifiers may be integrated into the beamforming radio 120 or may be separate amplifiers that are external to the radio 120), differences in the lengths of the RF transmission lines between the radio ports 122 and the respective sub-arrays 133 of radiating elements 134, temperature variations and the like. The calibration circuit 160 is used to tap small amounts of RF energy from the RF transmission lines 152 so that the beamforming radio 120 may measure how much the amplitudes and phases of the RF signals passed to the multi-column array 130 differ from the intended amplitudes and phases.

FIG. 2C is a schematic block diagram of the portion of the calibration circuit 160 of active antenna 100 for the −45° polarization radiators 136 of the radiating elements 134 in the first four columns 132-1 through 132-4 of the multi-column array 130 (FIG. 2C only illustrates this portion of the calibration circuit 160 to simplify the drawing). It will be appreciated that the circuitry shown in FIG. 2C will be doubled to account for the remaining four columns 132-5 through 132-8 of the multi-column array 130, and that an identical calibration circuit may be provided for the +45° polarization radiators 138 of the radiating elements 134 in each column 132.

As shown in FIG. 2C, the portion of the calibration circuit 160 that samples RF energy fed to the −45° polarization radiators of the radiating elements 134 in the sub-arrays 133 for the first four columns 132 of multi-column array 130 may be implemented on a calibration printed circuit board 162 (herein “calibration board”). First through eighth radio ports 122-1 through 122-8 of the beamforming radio 120 act as the inputs to the printed circuit board 162. As shown schematically in FIG. 2C, first through eighth RF transmission lines 152-1 through 152-8 that connect the filters 150 to the respective phase shifters 170 include segments that traverse the calibration board 162.

A plurality of directional couplers 166, where the number of directional couplers 166 may correspond to the number of RF transmission lines 152 (e.g., eight directional couplers 166 in the example of FIG. 2C), along with a calibration combiner 168 are formed on the calibration board 162. Each directional coupler 166 may be used to extract a small amount of any RF signal that passes along a respective one of the RF transmission lines 152. In the depicted embodiment, each directional coupler 166 is implemented as a trace 165 that extends generally in parallel next to a respective one of the RF transmission lines 152. When an RF signal travels along one of the RF transmission lines 152, a small portion of the RF energy will electromagnetically couple to the trace 165 so that together the trace 165 and the adjacent segment of the RF transmission line 152 form the directional coupler 166. The trace 165 may be referred to herein as the “tap port” of the directional coupler 166 as a small portion of the RF signal travelling along the RF transmission line 152 is tapped off to the trace 165.

As can further be seen in FIG. 2C, the calibration combiner 168 is implemented using seven 2×1 combiners 169 that together combine any RF signals present at the outputs of the eight directional couplers 166 into a single RF signal. As shown, the traces 165 of each set of two adjacent directional couplers 166 connect to the inputs of a respective one of four of the 2×1 combiners 169. A fifth 2×1 combiner 169 is used to combine the outputs of the first and second 2×1 combiners 169, and a sixth 2×1 combiner 169 is used to combine the outputs of the third and fourth 2×1 combiners 169. The seventh 2×1 combiner 169 combines the outputs of the fifth and sixth 2×1 combiners 169. The calibration board 162 may include crossover structures (not shown) that allow transmission line traces on the calibration board 162 to cross each other in an electrically isolated manner. The output of the seventh 2×1 combiner 169 may connect to a calibration cable that connects the calibration to the calibration port 124 of the beamforming radio 120.

The calibration circuit 160 extracts a small amount of each of the RF signals that are input to the sub-arrays 133 of the first four columns 132 of multi-column array 130 and then combines these extracted “calibration” signals and passes them back to the beamforming radio 120. The beamforming radio 120 may use this information to ensure that the amplitude and phase weights that are applied to the RF signals transmitted to the first four columns 132-1 through 1342-4 of radiating elements 134 generate optimized antenna beams.

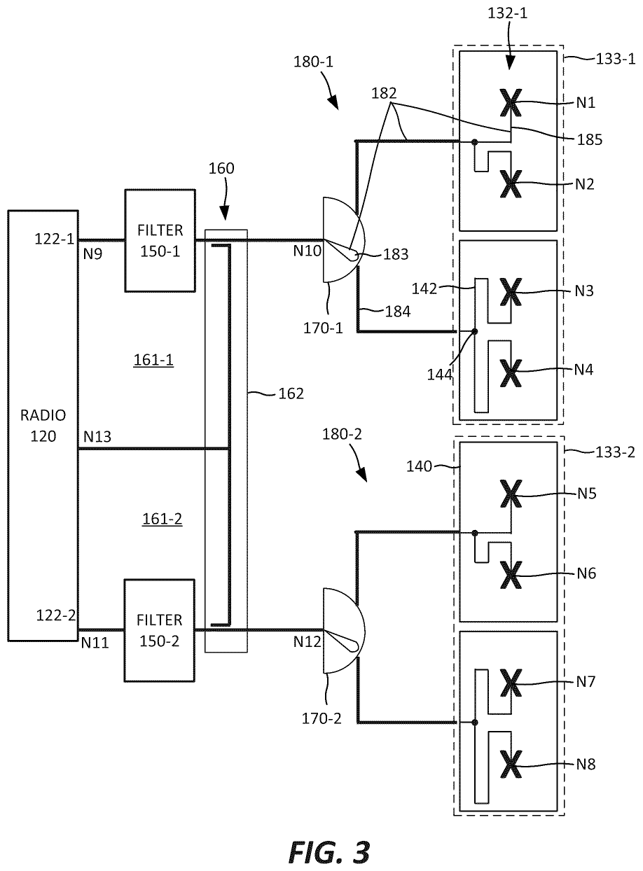

FIG. 3 is a schematic simplified block diagram illustrating a calibration loop 161 and first and second feed networks 180 for the first polarization radiators 136 of the radiating elements 134 in the first column 132-1 of the multi-column array 130. As shown in FIG. 3, a first port 122-1 of the beamforming radio 120 is connected to a first filter 150-1.

The output of the first filter 150-1 is connected to the calibration circuit 160, where a small portion of the RF energy output from the first port 122-1 of the beamforming radio 120 is tapped off and passed back to the beamforming radio 120. A first RF transmission line 152-1 extends from the calibration circuit 160 to the first feed network 180-1. In the depicted embodiment, the first feed network 180-1 includes an electromechanical phase shifter 170-1 that acts to both split RF signals input thereto into two sub-components and to apply a phase progression to the two sub-components that will add a desired amount of electrical downtilt to the antenna beams generated by a first sub-array 133-1 of radiating elements 134 included in the first column 132-1. As the structure and operation of electromechanical phase shifters are well known in the art, further discussion of phase shifter 170-1 will be omitted here. It will also be appreciated that the phase shifter 170-1 may be replaced with a power divider in other embodiments (e.g., a 1×2 power divider).

Still referring to FIG. 3, the phase shifter 170-1 (or the 1×2 power divider that is provided instead if the phase shifter 170-1 is omitted) sub-divides the RF signal that it receives from radio port 122-1 into two sub-components, applies a phase shift to each sub-component (if the phase shifter 170 is provided), and passes the two sub-components to the first polarization radiators 136 of the radiating elements 134 in the first sub-array 133-1 of radiating elements 134 that is included in the first column 132-1 of the multi-column array 130. The first feed network 180-1 includes a plurality of RF transmission paths 182-1 through 182-4. Each RF transmission path 182 is used to pass a sub-component of the RF signal that is input to the first feed network 180-1 to a respective one of the first polarization radiators 136 of the four radiating elements 134 in the first sub-array 133-1.

A second port 122-2 of the beamforming radio 120 is connected to a second filter 150-2. The output of the second filter 150-2 is connected to the calibration circuit 160, where a small portion of the RF energy output from the second port 122-2 of the beamforming radio 120 is tapped off and passed back to the beamforming radio 120. A second RF transmission line 152-2 extends from the calibration circuit 160 to the second feed network 180-2.

The first feed network 180-1 includes a first electromechanical phase shifter 170-1 that acts to both split RF signals input thereto into two sub-components and to apply a phase progression to the two sub-components that will add a desired amount of electrical downtilt to the antenna beams generated by a first sub-array 133-1 of radiating elements 134 included in the first column 132-1. The second feed network 180-2 includes a second electromechanical phase shifter 170-2 that acts to both split RF signals input thereto into two sub-components and to apply a phase progression to the two sub-components that will add a desired amount of electrical downtilt to the antenna beams generated by a second sub-array 133-2 of radiating elements 134 included in the first column 132-1. Each sub-array 133-1, 133-2 includes a total of four radiating element 134 that are, in each case, mounted on a pair of feedboards 140. As the structure and operation of electromechanical phase shifters are well known in the art, further discussion of phase shifters 170-1, 170-2 will be omitted here. It will also be appreciated that the phase shifters 170-1, 170-2 may be replaced with respective power dividers in other embodiments (e.g., 1×2 power dividers).

It will be appreciated that everything shown in FIG. 3 except for the radiating elements 134, the feedboards 140 and the beamforming radio 120 will be duplicated for the second polarization radiators 138 of the radiating elements 134 in column 132-1.

Various nodes are designated in FIG. 3 at different locations along the RF transmission paths from the first and second ports 122-1, 122-2 of the beamforming radio 120 to the radiating elements 134 in the first column 132-1, and additional nodes may be designated along the calibration loop 161 associated with the first polarization radiators 136 for the first column 132. These nodes include nodes N1 through N8 which are located at the inputs of the first polarization radiators 136 of the eight radiating elements 134 in column 132-1. A node N9 corresponds to the radio port 122-1 that feeds the −45° polarization radiators 136 of the radiating elements 134 in the first sub-array 133-1, and a node N10 corresponds to the point where RF signals output from radio port 122-1 are first divided into smaller sub-components (i.e., the input to the first feed network 180-1). A node N11 corresponds to the radio port 122-2 that feeds the −45° polarization radiators 136 of the radiating elements 134 in the second sub-array 133-2, and a node N12 corresponds to the point where RF signals output from radio port 122-2 are first divided into smaller sub-components (i.e., the input to the second feed network 180-2). Finally, a node N13 is the point where the calibration signals are fed back to the beamforming radio 120.

As shown in FIG. 3, two calibration loops 161-1, 161-2 are provided. The first calibration loop 161-1 extends from the first radio port 122-1, through the calibration board 162, and back to the radio 120 at calibration port 124. The second calibration loop 161-2 extends from the second radio port 122-2, through the calibration board 162, and back to the radio 120 at calibration port 124. As discussed above, a small amount of the RF energy of the RF signals output at each radio port 122-1, 122-2 is tapped from the RF transmission lines carrying the RF signals on the calibration board 162, and passed back to the calibration port 124 of radio 120, so that amplitude and/or phase inaccuracies in the RF signals that are generated in the beamforming radio and/or in the connections to the feed networks 180-1, 180-2 can be detected at the beamforming radio 120 (from the calibration signals) and the amplitude and phase weights applied in the beamforming radio 120 can be adjusted to correct any such errors.

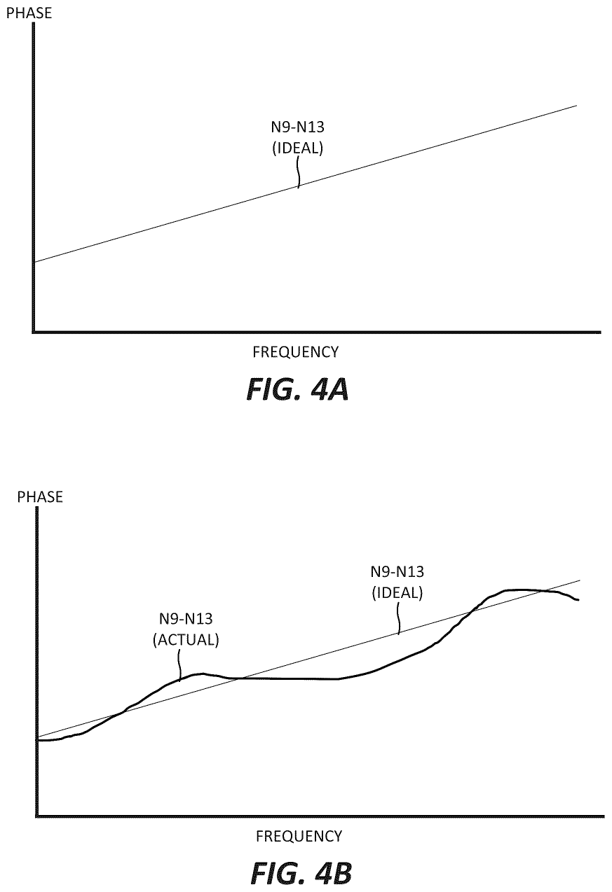

FIG. 4A is a schematic graph that illustrates the phase versus frequency response for RF signals traversing the first calibration loop 161-1 (i.e., the phase change or “shift” experienced by RF signals at different frequencies when traversing the first calibration loop 161-1) when it is assumed that the active antenna 100 is an ideal antenna. As shown in FIG. 4A, in an ideal antenna, the phase change experienced by RF signals traversing the first calibration loop 161-1 will vary linearly with frequency. Moreover, the phase shift that RF signals traversing the first calibration loop 161-1 at each frequency are values that are known in advance by the beamforming radio 120. As such, no phase errors will be introduced in the first calibration loop 161-1 in the ideal antenna that is assumed for the graph of FIG. 4A.

FIG. 4B shows the linear phase versus frequency response of FIG. 4A for the first calibration loop 161-1 of an ideal active antenna and, in addition, includes a second curve that illustrates the phase versus frequency response for RF signals traversing the first calibration loop 161-1 of a real world (i.e., non-ideal) active antenna. As shown in FIG. 4B, the phase change experienced by an RF signal traversing the first calibration loop 161-11 (i.e., passing from node N9 to node N13) in a real world (actual) active antenna will not vary linearly with frequency, but instead will differ from the “ideal” behavior at most frequencies, sometimes experiencing greater than expected phase changes and other times experiencing less than expected phase changes. Moreover, the beamforming radio 120 assumes that the phase versus frequency response will exhibit the ideal behavior shown in FIG. 4A. As such, the variation from the ideal phase versus frequency response shown in FIG. 4B means that in real world active antennas phase errors may be introduced in the calibration signals that are fed back to the beamforming radio 120. These phase errors will be reflected in phase weights applied by the beamforming radio 120, and may result in degraded beamforming performance.

It has been suggested that the variations shown in the phase versus frequency response for the real world active antenna shown in FIG. 4B can be measured in advance and provided to the beamforming radio 120. This would allow the beamforming radio 120 to correct the phase errors in the respective calibration loops 161, thereby improving beamforming performance. For example, when the beamforming radio 120 is transmitting at a first frequency f1, the beamforming radio 120 could access a file that contains the deviation from the ideal phase versus frequency response for each calibration loop 161, and read the value for the first frequency f1. The calibration data could then be corrected based on the deviation from ideal value for the first frequency f1. This will improve the accuracy of the calibration procedure.

It has been discovered that the phase versus frequency response for the feed networks (e.g., the feed networks 180 of active antenna 100) that are used in most active antennas may also differ from the expected “ideal” behavior. These deviations may occur for a variety of reasons, such as temperature variations and because of crosstalk between RF transmission lines. As will be explained below, these deviations from the ideal phase versus frequency response for the feed networks 180 can also degrade the beamforming performance of an active antenna.

Referring again to FIG. 3, four RF transmission paths 182-1 through 182-4 are provided that extend from the input of the first feed network 180-1 to a respective one of the radiating elements 134-1 through 134-4 in the first sub-array 133-1. Each RF transmission path includes a first portion 183 that extends through the first phase shifter 170-1, a second portion 184 that connects an output of the first phase shifter 170-1 to either feedboard 140-1 or feedboard 140-2, and a third portion 185 that is on either feedboard 140-1 or feedboard 140-2. The first portions 183 are typically implemented as microstrip traces within the first phase shifter 170-1. The second portions 184 are typically implemented using coaxial cables. The third portions 185 are typically implemented using the RF transmission lines 142 (which may be, for example, microstrip traces) on the feedboards 140. Note that in a typical implementation each first portion 183 and each second portion 184 as well as a segment of each third portion 185 may be part of two of the RF transmission paths 182. The four RF transmission paths 182-5 through 182-8 that are provided in the second feed network 180-2 may have the same design and hence further discussion of these RF transmission paths 182 will be omitted.

As shown in FIG. 3, the lengths of the third portions 184 of the RF transmission paths 182 may differ from each other in order to apply a desired phase progression to the sub-components of the RF signal that are passed to the first polarization radiators 136 of the four radiating elements 134 in each sub-array 133. In the example shown in FIG. 3, the RF transmission paths 182 to radiating elements 134-1 and 134-5 (which extend from node N10 to node N1 and from node N12 to node N5, respectively) are the shortest RF transmission paths 182. As shown, typically these two RF transmission paths 182 will have the same electrical length. The RF transmission paths 182 that extend to radiating elements 134-2 and 134-6 (which extend from node N10 to node N2 and from node N12 to node N6, respectively), are the next shortest RF transmission paths 182, and the electrical length of these two RF transmission paths 182 may also be the same. The RF transmission paths 182 to radiating elements 134-3 and 134-7 (which extend from node N10 to node N3 and from node N12 to node N7, respectively), are the next shortest RF transmission paths 182, and the electrical length of these two RF transmission paths 182 may also be the same. Finally, the RF transmission paths 182 to radiating elements 134-4 and 134-8 (which extend from node N10 to node N4 and from node N12 to node N8, respectively) are the longest RF transmission paths 182, and the electrical length of these two paths may also be the same.

In many situations, the RF transmission lines 142 on the feedboards 140 (which form the third portion 185 of each RF transmission path 182 in the present embodiment) may pass very close to each other, because the columns 132 of radiating elements 134 may be spaced very close together (e.g., as close as half a wavelength that corresponds to the center frequency of the operating frequency band of the multi-column array 130), and because there is not much room on the feedboards 140 for the RF transmission lines 142. Because of the proximity between the RF transmission lines 142 (and the proximity of different segments of the same RF transmission line 142), RF signals passing along these RF transmission lines 142 and segments thereof may interact with each other, resulting in crosstalk between transmission line segments.

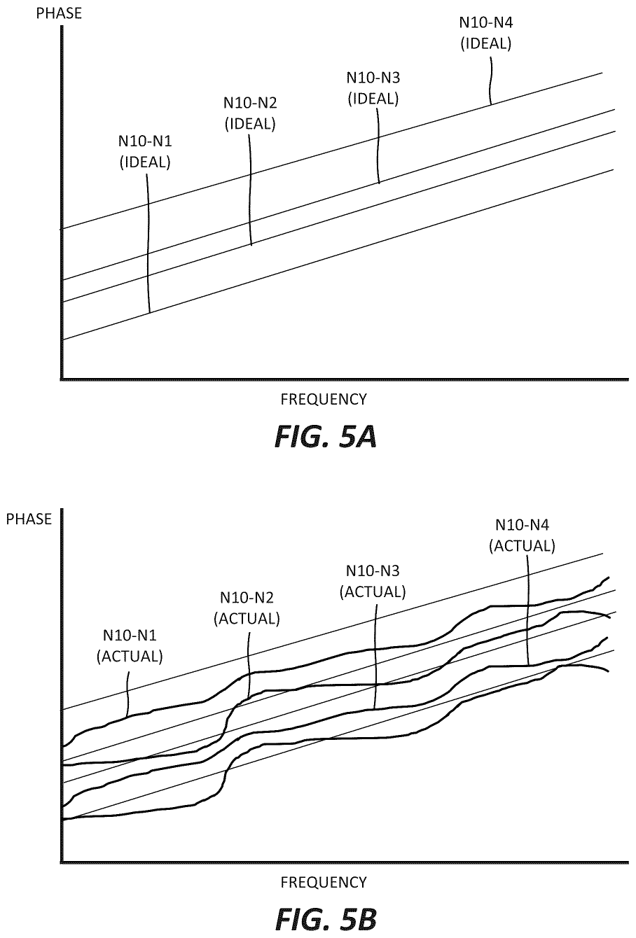

In an ideal antenna, the phase versus frequency response for the RF signals that pass from node N10 to each of the radiating elements 134 in the first sub-array 133-1 will be linear (for a fixed setting of phase shifter 170-1), as will the phase versus frequency response for the RF signals that pass from node N12 to each of the radiating elements 134 in the second sub-array 133-2. In other words, at every frequency in the operating frequency band, the phase change that an RF signal experiences as it passes along a respective one of the RF transmission paths 182 will experience a known amount of phase shift, and the phase shift will change linearly with frequency. This is shown schematically in FIG. 5A for the RF transmission paths that feed the radiating elements 134 of the first sub-array 133-1. As shown, in an ideal antenna each phase versus frequency response is linear. As is also shown in FIG. 5A, the longer the RF transmission path 182 the more the amount of phase change experienced at a given frequency.

Because of the above-discussed crosstalk and other imperfections, the phase versus frequency response for RF signals traversing the RF transmission paths 182 will not be linear in a real world (actual) antenna. An example of an expected real world phase versus frequency response is shown schematically in FIG. 5B. As shown, the phase versus frequency response will be non-linear, although it may generally track the “ideal” performance. The unintended variations from ideal in the amount of phase shift that an RF signal experiences when traversing one of the RF transmission paths 182 (which variations differ non-linearly with frequency) that are shown FIG. 5B will not be detected by the calibration loops 161-1, 161-2 for sub-arrays 133-1, 133-2, respectively, as the calibration loops 161-1, 161-2 do not extend through the respective feed networks 180-1, 180-2. Consequently, at any given operating frequency, to the extent that the phase versus frequency response shown in FIG. 5B differs from the ideal relationship shown in FIG. 5A, then the phase offset from the ideal response at this frequency will result in an unintended phase error in the RF signals transmitted by the radiating elements 134 in column 132-1. The same effect occurs at each of the remaining columns 132 in the multi-column array 130. The net effect of these phase errors is that the antenna beams formed by the multi-column array 130 will vary from their intended shapes, typically resulting in reduced directivity, higher sidelobe levels, unintended variations in pointing direction and/or degraded antenna beam shape.

As discussed above, pursuant to embodiments of the present invention, the phase versus frequency response of each feed network 180 in the multi-column array 130 may be determined in advance. For example, before an active antenna is shipped from the factory, RF signals may be input to each sub-array 133 of the multi-column array 130 and the phase (and amplitude) of the RF signals at the inputs to each radiating element 134 in the multi-column array 130 may be measured. Such measurements may be performed at different frequencies across the operating frequency band for the multi-column array (e.g., at 1 MHz intervals). This information may be stored in an electronic file that may ultimately be read into beamforming radio 120. During operation, beamforming radio 120 may be programmed to read the amplitude and/or phase information from the electronic file (e.g., the phase shift to each radiating element 134) at the frequency at which the beamforming radio 120 is operating and apply weight corrections that account for the offsets from the ideal phases due to imperfections in the feed networks 180. For example, if the average offset from the ideal phase for the radiating elements 134 in a given sub-array 133 is 20°, then the radio may apply a −20° phase correction. In this manner, the impact of unintended phase variations in the feed networks 180 on the performance of the multi-column array 130 may be reduced or eliminated.

It will be appreciated that the information reflecting the unintended phase variations in the feed networks 180 may take a variety of different forms. For example, in some embodiments, the information can simply be the actual phase changes experienced by the sub-components of the RF signals as they traverse the feed network 180 (or a predefined portion thereof). In other embodiments, the information may be differences between the measured phases and the expected phase if the antenna was an ideal antenna. Other similar parameters may be used. It will also be appreciated that while the discussion above focuses on unintended variations in the phase of the RF signals at each radiating element, the same type of information may alternatively or additionally be recorded with respect to unintended variations in the amplitudes of the RF signals at each radiating element, and the techniques disclosed herein may be used to correct phase errors, amplitude errors, or both that arise in the feed networks 180. As discussed above, the information regarding the unintended variations in the phase (and/or amplitude) of the RF signals as the RF signals traverse the RF transmission paths 182 through the feed networks 180 may be determined for a wide range of frequencies. This phase information for each RF transmission path 182 constitutes a phase versus frequency response for the RF transmission path 182.

The determined phase information (and/or amplitude information) may be stored electronically, and may be made available to a manufacturer or user of the active antenna 100 so that the information may be input to a beamforming radio 120 that will be used in conjunction with the beamforming array 130. In some embodiments, the phase information may be shipped with the active antenna 100 (e.g., in a separate memory storage device such as a memory stick). In other cases, an address (e.g., an Internet address) where the information is available may be printed on the active antenna 100 or encoded in a bar code or the like on the antenna. In still other embodiments, the phase information may be encoded in QR codes or the like that are provided on or with the antenna. In other embodiments, the phase information may be electronically delivered to the manufacturer or user of the active antenna 100 (e.g., by email). Other techniques may be used. The important point is that the information is made available so that it can be uploaded into the beamforming radio 120 that is used with active antenna 100.

It will also be appreciated that information other than phase information may be uploaded into the beamforming radio 120. As described above, the beamforming radio 120 may use the phase information to generate corrective weights that are applied to at least partially offset the phase errors in the feed networks 180. The beamforming radio may calculate these phase weights based on the above-described phase information. In some cases, it may be more efficient for the active antenna manufacturer to determine the corrective phase weights based on the phase information. In such cases, the information uploaded to the beamforming radio 120 may be the corrective weights. Thus, it will be appreciated that a variety of different types of information may be uploaded to the beamforming radio in practicing the techniques disclosed herein for at least partially compensation for amplitude and/or phase errors that are generated in the feed networks 180 of a beamforming array 130.

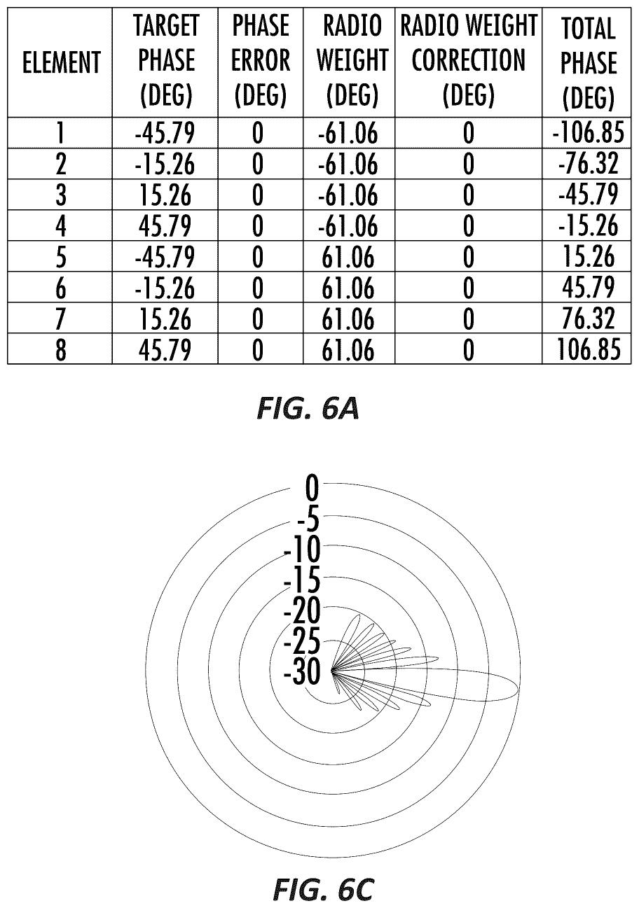

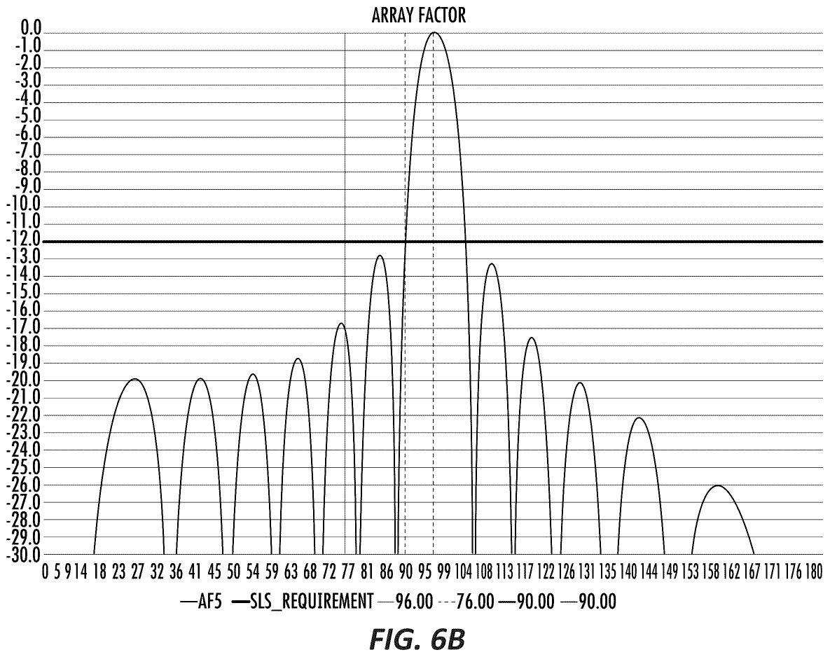

FIGS. 6A-8C provide one simple example that illustrates how the techniques disclosed herein may improve the performance of the active antenna 100. Referring first to FIG. 6A, a table is provided that illustrates the ideal or “target” phase for each of the eight radiating elements 134 in column 132-1 of multi-column array 130 in the case of an ideal antenna. Here, the target phase may be, for example, the phases of the RF signals at the first polarization dipole radiators 136 of the radiating elements 134. FIG. 6A represents the “ideal” antenna case so it is assumed that the deviation from the target phase is zero degrees (i.e., the phase error for each radiating element 134 is zero). Example radio weights are also shown in the table of FIG. 6A, which represent the phase weights that are applied by the beamforming radio 120 to the RF signals output at each port of the beamforming radio 120 that will result in an antenna beam having a desired shape. Since each first polarization RF port 122-1, 122-2 that feeds the first column 132-1 is connected to four radiating elements 134, the same first phase weight is applied to the first four radiating elements 134 (i.e., the radiating elements in the first sub-array 133-1), and the same second phase weight is applied to the remaining four radiating elements 134 (i.e., the radiating elements in the second sub-array 133-2). Since FIG. 6A represents the ideal case, no correction is applied to the radio weights, as is also shown in FIG. 6A. The final column in FIG. 6A is the total phase of the RF signals transmitted by each radiating element 134 in the column 132-1, where the total phase is the sum of the target phase, the phase error, the radio phase weight and the radio phase weight correction.

FIGS. 6B and 6C are elevation plots, in Cartesian and Polar formats, respectively, of the antenna beam generated by column 132-1 assuming that the multi-column array 130 is an ideal array having the target phases shown in FIG. 6A and fed with RF signals having the radio phase weights shown in FIG. 6A. As shown in FIGS. 6B and 6C the antenna beam generated by column 132-1 of such an ideal antenna has a high gain, low sidelobes, and very low RF energy levels between lobes in the elevation plane.

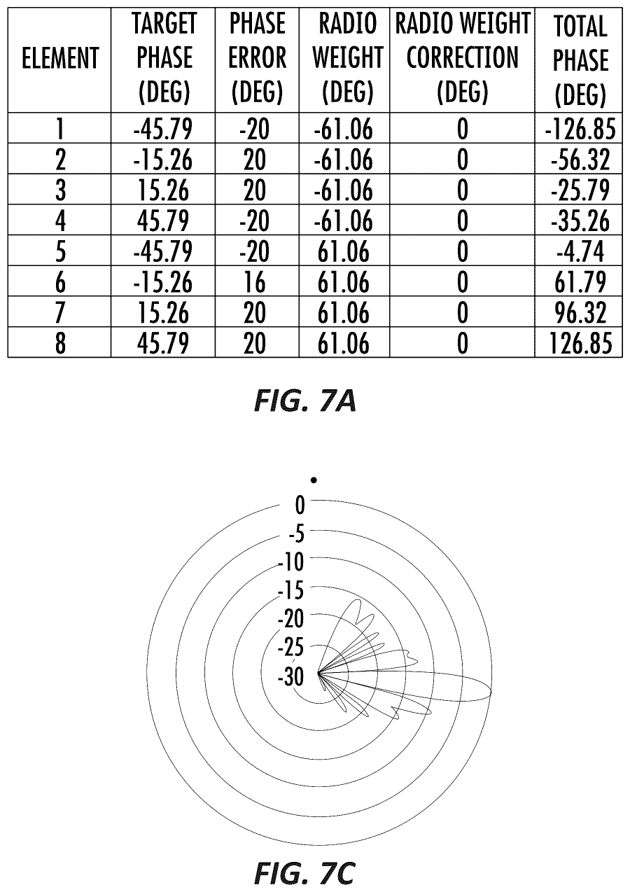

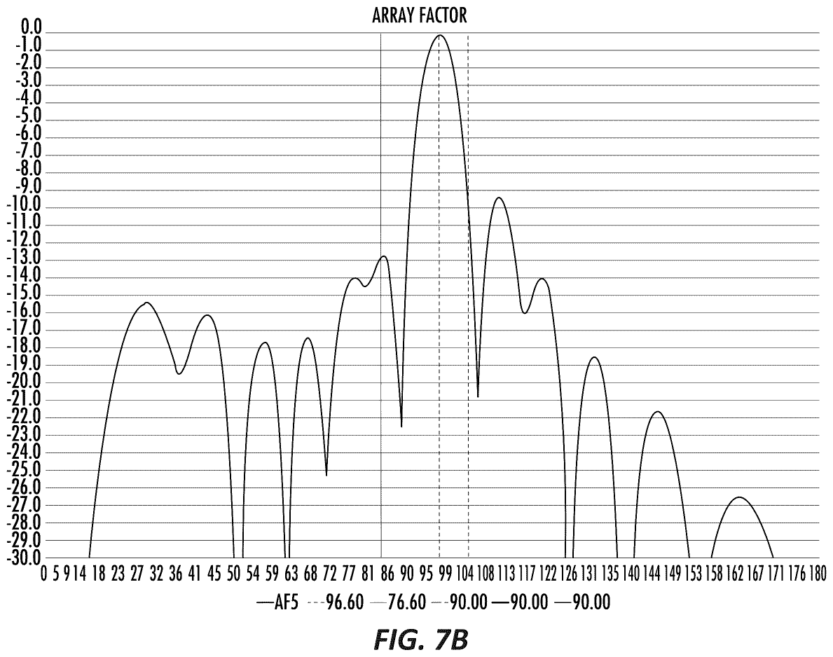

FIG. 7A is a table that illustrates the phase behavior of an example actual antenna. As can be seen by comparing FIGS. 6A and 7A, some degree of phase error will typically exist along the RF transmission paths 182 to each radiating element 134 in the column 132-1, and this phase error results in the “total phases” shown in the rightmost column of the table of FIG. 7A, which differ from the desired total phases, which are shown in the rightmost column of the table of FIG. 6A.

The negative impact of the phase errors listed in the table of FIG. 7A can be seen in the corresponding Cartesian and Polar elevation plots of FIGS. 7B and 7C. As shown, the sidelobes in the elevation plane increases in both size and in magnitude as compared to the sidelobe levels shown in FIGS. 6B and 6C. Additionally, the peak directivity of the antenna beam is reduced by nearly 0.5 dB, and the downtilt angle of the main lobe is shifted by 0.6 dB. All of these changes to the antenna beam are undesirable, and act to degrade the performance of the active antenna 100.

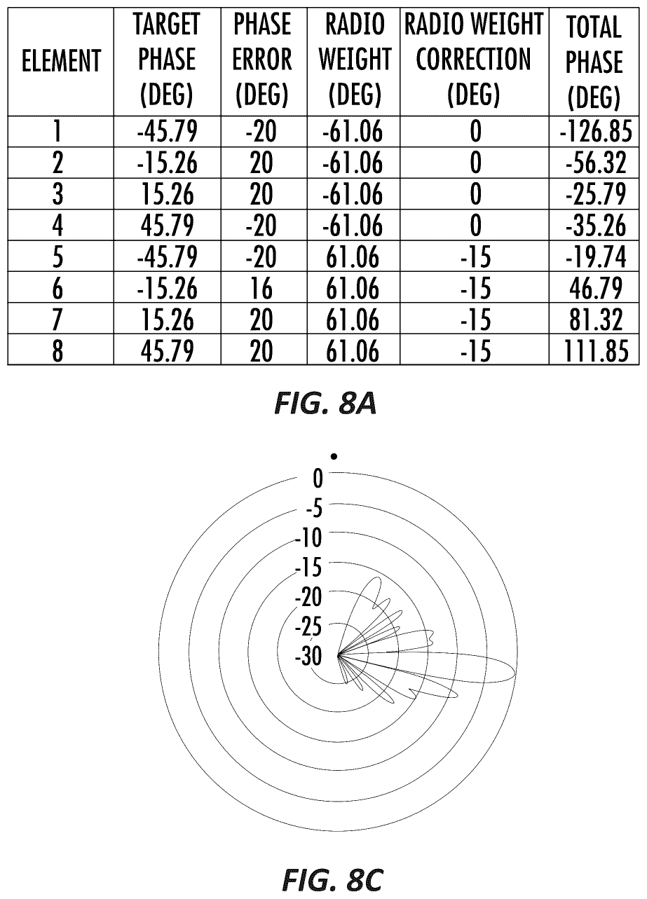

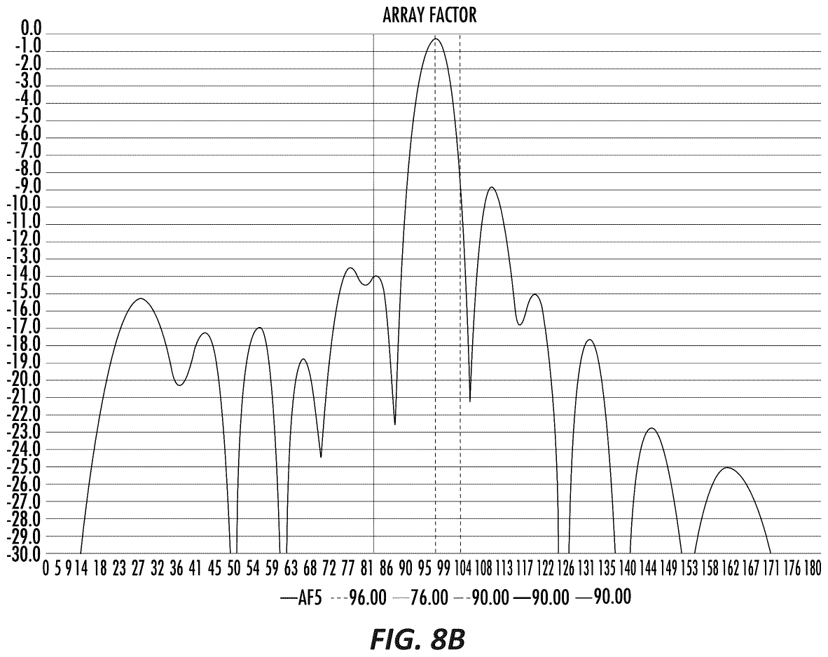

FIG. SA is a table that illustrates how phase weight corrections may be applied by the beamforming radio 120 that may at least partially counter the negative effects of the phase errors in the feed networks 180 that are shown in the tables of FIG. 7A and FIG. 8A. As shown in the simple example of FIG. 8A, weight corrections of −15° are applied by the beamforming radio 120 to the weights applied to radiating elements 134-5 through 134-8. Note that since all four radiating elements 134-5 through 134-8 are part of the same sub-array 133-2, it is necessarily the case that the same corrective weight is applied to the RF signals that are fed to all four radiating elements 134-5 through 134-8 The impact of these phase weight corrections can be seen in the corresponding Cartesian and Polar elevation plots of FIGS. 8B and 8C, respectively. As shown in this simple example, the maximum sidelobe levels are reduced from the sidelobe levels shown in FIGS. 7B and 7C, and the 0.6 degree offset in the desired downtilt error that was present in the example of FIGS. 7B-7C was eliminated. A slight increase in directivity was also observed. Thus, it can be seen that by determining the phase errors in the feed networks 180 and then having the beamforming radio 120 apply corrective phase weights that partially or fully correct for these phase errors, the performance of a multi-column array 130 can be improved. It will be appreciated that the phase weight corrections shown in FIG. 8A are not the ideal corrections-they simply show how weight corrections can improve performance. The ideal weight corrections would be corrections that fully eliminate the unintended phase errors that are introduced in the real world feed networks so that the multi-column array will exhibit antenna beams that are much closer to the “ideal” performance shown in FIGS. 6B-6C (although it will be understood that such “ideal” performance will not occur in real world antennas due to other non-ideal aspects of the beamforming radio 120 and multi-column array 130). It will also be appreciated that the corrective phase weights may be separate weights that are applied by the beamforming radio 120 or adjustments that are made to the initial radio weights.

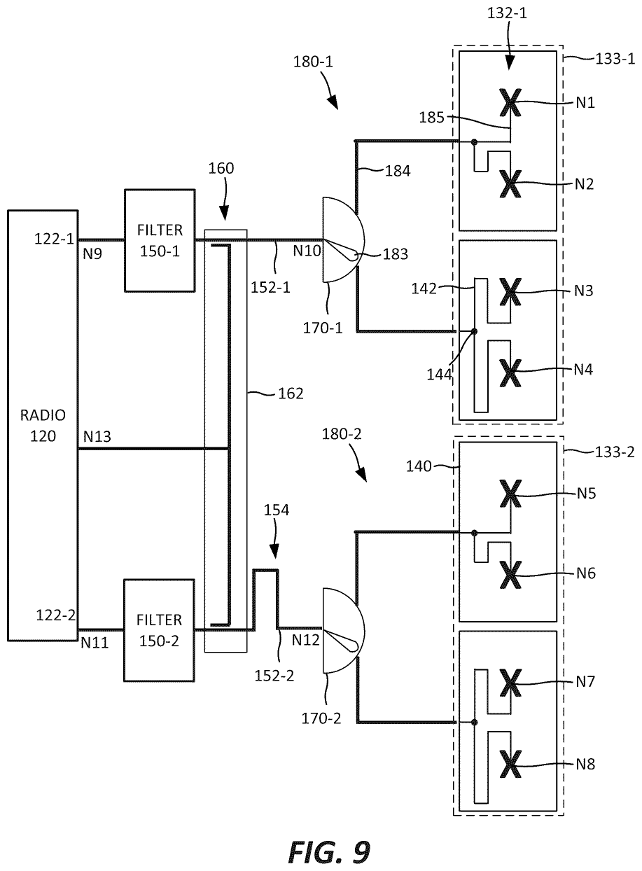

The techniques disclosed herein may also be used to correct for other unintended imperfections in the multi-column array 130 that can degrade the performance thereof. For example, FIG. 9 is a schematic block diagram of the first column 132-1 of multi-column array 130 of an active antenna 100′. As can be seen by comparing FIGS. 3 and 9, active antenna 100′ may be identical to active antenna 100 of FIG. 3 except that the electrical lengths of the RF transmission paths 152-1 and 152-2 that extend between the first and second filters 150-1, 150-2 and the respective inputs to the first and second feed networks 180-1, 180-2 have the same length in active antenna 100, while they have different lengths in active antenna 100′ (as shown by the meandering 154 of RF transmission path 152-2 in FIG. 9). Such differences may occur in multi-column arrays where the radiating elements and feedpoints are not symmetrical. The differences in RF transmission path lengths may be differences between sub-arrays 133 that are part of the same column 132 (as shown in FIG. 9) or sub-arrays 133 that are part of different columns 132 of the multi-column array 130. It should be noted that most multi-column arrays operate in relatively high frequency bands (e.g., portions of the 3.1-4.2 GHz band). At these frequencies, the wavelengths are very small. For example, at 4.2 GHz, a wavelength is 71 mm, meaning that a difference in path length of only 1 mm may result in a phase deviation of about 5° for a 4.2 GHz RF signal. Thus, even small differences in the length of an RF transmission path may result in non-trivial phase changes.

Notably, since the above described techniques determine the actual phase shifts experienced by the RF signals traversing the RF transmission paths 182, any unintended differences in the RF path lengths from the outputs of the filters 150 to the inputs of the feed networks 180 for a column 132 may be captured by the above-discussed phase error file, and hence will be accounted for by the phase weight corrections applied by the beamforming radio 120.

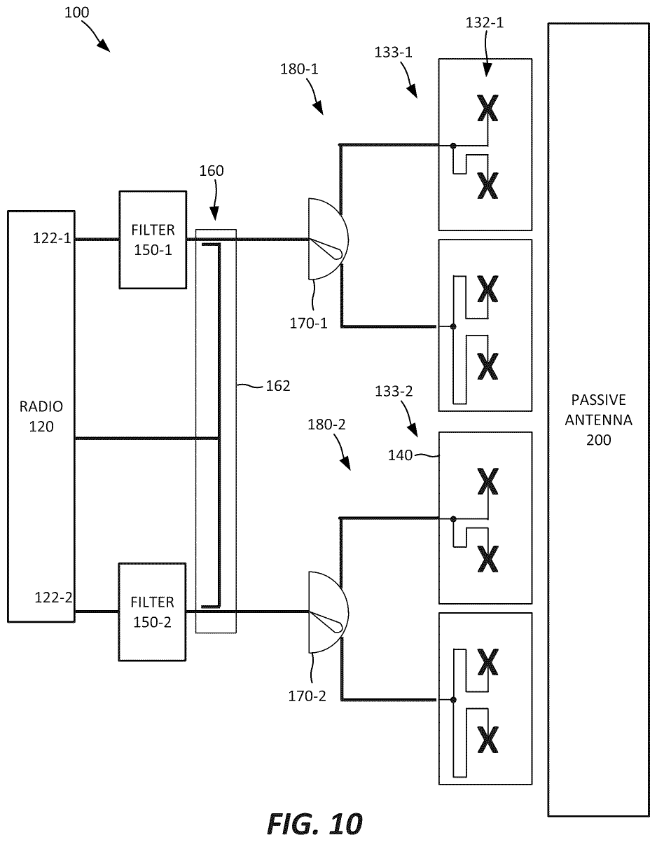

FIG. 10 is a schematic block diagram illustrating portions of a base station antenna system that includes a passive base station antenna 200 and an active antenna 100 mounted behind the passive antenna 200. The active antenna may, for example, have the design of the active antenna 100 of FIGS. 2A-2C. There is currently significant demand base station antenna systems having the configuration shown in FIG. 10. The passive base station antenna 200 may include a plurality of linear arrays of radiating elements (not shown) that, for example, support second generation (“2G”), third generation (“3G”) and/or fourth generation (“4G”) cellular service. The active antenna 100 may, for example, be a stand alone antenna that includes at least one multi-column array 130 of radiating elements 134 and a beamforming radio 120. As shown schematically in FIG. 10, the active antenna 100 may be mounted on or at the rear of the passive base station antenna 200. The reflector (not shown) of the passive base station antenna 200 may include an opening and/or a frequency selective surface that will allow RF radiation emitted by the multi-column array 130 of radiating elements 134 of the active antenna 100 to pass through the passive base station antenna 200 so that the antenna beams generated by the multi-column array 130 exit the front of the passive base station antenna 200.

As discussed above, the RF transmission paths 182 in the feed networks 180 may include unintended phase errors that differ for each RF transmission path 182 and which also differ as a function of frequency. As is also discussed above, the techniques disclosed herein may be used to at least partially correct for these unintended phase (and amplitude) errors in the feed networks 180 for the multi-column array 130.

It has been discovered that the unintended phase errors that arise in the RF transmission paths 182 of the feed networks 180 of the multi-column array 130 in active antenna 100 may change when the active antenna 100 is mounted behind the passive base station antenna 200. These changes may occur because of coupling between the RF transmission paths 182 and metal structures in the passive base station antenna 200.

Pursuant to further embodiments of the present invention, unintended phase changes that arise in the RF transmission paths 182 of a feed network 180 for a multi-column array 130 when the multi-column array 130 is mounted behind a passive base station antenna 200 may be measured. A beamforming radio 120 that is used in conjunction with the multi-column array 130 may be programmed to apply corrective weights that at least partially compensate for the unintended phase changes that arise in the RF transmission paths 182 due to couplings or other interactions between the passive base station antenna 200 and the active antenna 100.

In one example embodiment, a network analyzer may be used to generate phase versus frequency responses for each RF transmission path 182 through the feed networks 180 active antenna 100. These responses are generated before the active antenna 100 is mounted behind the passive base station antenna 200. The active antenna 100 is then mounted behind the passive base station antenna 200 and the phase versus frequency responses for each RF transmission path 182 through the feed networks 180 active antenna 100 are again measured. The differences between the two phase versus frequency responses for each RF transmission path 372 represents the unintended phase errors that are caused by mounting the active antenna behind the passive base station antenna 200. Based on these identified errors, corrective weights may be determined that are applied by the beamforming radio to at least partially compensate for the unintended phase errors that are caused by mounting the active antenna behind the passive base station antenna 200.

The base station antennas according to embodiments of the present invention may exhibit improved performance in terms of antenna beam shape, pointing direction, sidelobe levels and/or directivity. Moreover, these improvements may be achieved without any countervailing degradations in the performance of other parameters.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some elements may not be to scale.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

It will be understood that features illustrated with one example embodiment above can be incorporated into any of the other example embodiments. Thus, it will be appreciated that the disclosed embodiments may be combined in any way to provide many additional embodiments.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

1. A method of operating a beamforming antenna system that includes a multi-column array of radiating elements and a beamforming radio, the method comprising:
adjusting weights applied in the beamforming radio based on data corresponding to phase versus frequency responses for a plurality of feed networks for respective sub-arrays of radiating elements included in a first column of radiating elements of the multi-column array of radiating elements.

2. The method of claim 1, wherein the data corresponding to the phase versus frequency responses for the plurality of feed networks for the respective sub-arrays of radiating elements included in the first column of radiating elements comprises information regarding the relative phase shifts for sub-components of radio frequency (“RF”) signals traversing the feed networks to each radiating element in the first column of radiating elements for a plurality of different frequencies.

3. The method of claim 1, the method further comprising measuring the data corresponding to the phase versus frequency responses of the plurality of feed networks for the respective sub-arrays of radiating elements included in the first column of radiating elements.

4. The method of claim 3, the method further comprising inputting into the beamforming radio the measured data corresponding to the phase versus frequency responses of the plurality of feed networks for the respective sub-arrays of radiating elements included in the first column of radiating elements.

5. The method of claim 3, the method further comprising determining corrective weights based on the measured data corresponding to the phase versus frequency responses of the plurality of feed networks for the respective sub-arrays of radiating elements included in the first column of radiating elements and then inputting the corrective weights into the beamforming radio.

6. The method of claim 1, wherein the data corresponding to the phase versus frequency responses of the plurality of feed networks for the respective sub-arrays of radiating elements included in the first column of radiating elements comprises measured phase shifts for each radiating element in the first column at a plurality of different frequencies.

7. The method of claim 1, wherein the adjustment to the weights applied in the beamforming radio are also based on data corresponding to an amplitude versus frequency response of the plurality of feed networks for the respective sub-arrays of radiating elements included in the first column of radiating elements.

8. The method of claim 1, the method further comprising adjusting weights applied in the beamforming radio based on data corresponding to the phase versus frequency responses of a plurality of feed networks for the respective sub-arrays of radiating elements included in each of the columns of radiating elements in the multi-column array of radiating elements other than the first column.

9. A method of operating a beamforming antenna system that includes a multi-column array of radiating elements and a beamforming radio, the method comprising:
adjusting weights applied in the beamforming radio to radio frequency (“RF”) signals that are output to at least some of a plurality of sub-arrays of the multi-column array of radiating elements based on information regarding the phase shifts experienced by RF signals when traversing the feed networks that connect respective ports of the beamforming radio to each radiating element in the multi-column array of radiating elements.

10. The method of claim 9, wherein the information regarding the phase shifts experienced by RF signals when traversing the feed networks that connect the ports of the beamforming radio to each radiating element in the multi-column array of radiating elements includes information regarding the phase shifts experienced by RF signals when traversing the feed networks that connect the ports of the beamforming radio to each radiating element in the multi-column array of radiating elements for each of a plurality of different frequencies.

11. The method of claim 9, the method further comprising measuring the information regarding the phase shifts experienced by the of RF signals passed from the beamforming radio to each radiating element in the multi-column array of radiating elements at the plurality of different frequencies.

12. The method of claim 11, the method further comprising inputting the information regarding the relative phases of RF signals passed from the beamforming radio to each radiating element in the multi-column array of radiating elements at the plurality of different frequencies into the beamforming radio.

13. The method of claim 9, wherein the information regarding the relative phases of RF signals passed from the beamforming radio to each radiating element in the multi-column array of radiating elements at the plurality of different frequencies comprises measured phase values for each radiating element in each column at the plurality of different frequencies.

14. A method of at least partially compensating for phase errors in feed networks for respective columns of a multi-column array of radiating elements, the method comprising:
determining phase shifts experienced by the respective sub-components of a radio frequency (“RF”) signal traversing a feed network for a first column of radiating elements of the multi-column array of radiating elements at a plurality of different frequencies; and
storing the determined phase shifts.

15. The method of claim 14, wherein the phase delay information is stored in an electronic file.

16. The method of claim 14, the method further comprising inputting the determined phase shifts into the beamforming radio.

17. The method of claim 16, the method further comprising adjusting weights applied by the beamforming radio based on the determined phase shifts.

18. The method of claim 14, wherein determining the phase shifts experienced by the respective sub-components of the RF signal traversing a feed network for a first column of radiating elements information for the at least some of the radiating elements in the multi-column array of radiating elements at the plurality of different frequencies comprises inputting first RF signals having the plurality of different frequencies to a feed network for the first column of radiating elements and measuring phases of second RF signals that are provided at each radiating element in the first column of radiating elements in response to the first RF signals.

19. A method of determining phase errors in a feed network for a first column of radiating elements of a multi-column array of radiating elements, the method comprising:
measuring data corresponding to a phase versus frequency responses of a plurality of feed networks for the first column of radiating elements.

20. The method of claim 19, wherein the measured data corresponding to the phase versus frequency response of the feed network for the first column of radiating elements comprises measured phase delay information to each of the radiating elements in the first column for a plurality of different frequencies.

21-24. (canceled)
